(19) United States
(12) Patent Application Publication
(10) Pub. No.: US 2003/0115311 A1
(43) Pub. Date: Jun. 19, 2003

(54) Enterprise network infrastructure for mobile users

(75) Inventors: Duncan Johnston-Watt, Kent (GB); Andrew Martin West, Hampshire (GB); Richard Philip Kilsby, London (GB); Michael Paull, London (GB)

Correspondence Address: BEYER WEAVER & THOMAS LLP, P.O. BOX 778, BERKELEY, CA, 94704-0778, US

(73) Assignee: Enigmatec Corporation

(21) Appl. No.: 10/306,515

(22) Filed: Nov. 27, 2002

Related U.S. Application Data
(60) Provisional application No. 60/334,291, filed on Nov. 29, 2001.

(51) Int. Cl. G06F 15/173

(52) U.S. Cl. 709/223

(57) ABSTRACT

In the present invention, we provide a run-time infrastructure that dynamically adapts enterprise content and services in order to maximise their value to the mobile user. The system takes account of changes in both the mobile user's business context, typically represented by their calendar and scheduled tasks, and their physical environment, typically represented by the available QoS. This is used to determine what content to source or services to offer to mobile users.

### FIELD OF THE INVENTION

The present invention addresses the problems of effective and efficient mobile working in the Business-to-Employee (B2E) and Business-to-Client (B2C) domains. In particular, it addresses those issues associated with the design of a mobile applications infrastructure to ensure that the enterprise derives the maximum business benefit.

### BACKGROUND TO THE INVENTION

Peter Deutsch's seven fallacies of distributed computing are made by almost everyone the first time they build a distributed application. These inevitably result in a flawed implementation. The original list has been augmented and now reads:

The network is reliable

Latency is zero

Bandwidth is infinite

The network is secure

Topology doesn't change

There is one administrator

Transport cost is zero

The network is homogeneous

In order to make a system robust we need take into account two additional fallacies:

The network is stable

Resources are infinite

The emergence of powerful, always on, voice capable personal communicators has the potential to dramatically enrich the way we interact with the world around us. This will radically transform the mobile experience and enable the enterprise to develop sophisticated mobile solutions that will quickly deliver measurable productivity gains and a quantifiable return on investment.

However, this potential will only be realized if an intelligent infrastructure is created that takes into account the intrinsic volatility of the network itself. Furthermore, this infrastructure needs to be seamlessly integrated with and extend an enterprise's existing workflow model and application suite.

The importance of the personal communicator class device as a productivity tool is also intrinsically linked to the quality of experience delivered to mobile users. Unless mobile users can rely upon these devices wherever they are, whatever they are doing, to access cost-effective, well-behaved services whenever they need them, and unless a dynamic user experience that is attuned to the environment can be delivered, it will not be possible to realize the full benefits of mobile services.

### SUMMARY OF THE INVENTION

According to one aspect of the present invention, a system for providing content over a network from an enterprise to a mobile user comprises an enterprise network infrastructure interface application that is operative to modify the delivery of content to a user's communications device over the network in accordance with a user profile maintained within the system which is updated in response to one or more event streams generated within the system that describe changes associated with the environment in which the user operates.

According to another aspect of the present invention, a method of providing content over a network from an enterprise to a mobile user comprises the steps of receiving one or more event streams that describe changes associated with the environment in which the mobile user operates, updating a user profile associated with the mobile user in dependence on the received event streams, and subsequently modifying the delivery of content to the mobile user in dependence on the updated user profile.

According to yet another aspect of the present invention, a computer program product comprises computer executable code that is operative to receive event streams that describe changes associated with the environment in which a mobile user operates, update a user profile associated with the mobile user in dependence on the received event streams, and subsequently modify the delivery of content to the mobile user in dependence on the updated user profile.

In the present invention, we provide a run-time infrastructure that dynamically adapts enterprise content and services in order to maximise their value to the mobile user. The system takes account of changes in both the mobile user's business context, typically represented by their calendar and scheduled tasks, and their physical environment, typically represented by the available QoS. This is used to determine what content to source or services to offer to mobile users.

In the present application, the term “mobile user” encompasses a person who accesses information technology (IT) services from different physical locations and/or different communications devices. In other words, it is the user who is mobile and we address the problem of providing a connection to the infrastructure of an enterprise for that user. For example, for an office worker, the user may need to log onto a network at different locations within the organisation, for example when hot-desking is required, or when “drop-in” centres are provided. Home workers may have to connect not only when they are at home, but also when they are on the move, and when they are actually in the office. The communications devices may be static desktop computers, laptop computers, mobile personnel communicators or personnal digital assistants (PDA) etc. Such devices may be connected via a wired or wireless connection, for example 3G, GPRS, Bluetooth etc.

The term “modify the delivery of content” encompasses the actual content that is identified for delivery, the manner in which content is actually delivered, the priority given to content for delivery and access (including the manner in which access is presented) to content of one form or another, and the frequency of delivery of content.

The term “content” encompasses application or domain specific data. The term also incorporates an abstract of content or a link to content. The system typically includes mechanisms that support a number of different content types and methods for providing content in a format suitable for the prevailing conditions at the time of delivery of content. The term “environment” encompasses both user context and business context factors. For example, environmental factors such as time, place, accessibility (otherwise known as “presence”) and the mobile user's role or tasks, both private (personal) and business related, may be considered. Changes associated with these environmental factors are processed within the system to generate event streams that are subsequently processed by the network infrastructure interface application. The event streams may be generated locally or at a remote location. The network infrastructure interface application may itself generate one or more event streams in response to changes in the user's environment, whether these changes are presented to the application as raw data or as an event stream.

Preferably, the network infrastructure interface application comprises a profile manager portion that receives event streams and which is responsive to update a user profile in dependence on the event streams.

Preferably, the profile manager portion is driven by a set of Event-Condition-Action (ECA) rules.

Preferably, the network infrastructure interface application comprises a content manager portion that is responsive to changes in a user profile to modify the delivery of content to the mobile user. In a preferred embodiment, the content manager portion forms part of an adaptive content engine. This is a set of distributed server components that implements dynamic rules-based selection, prioritisation and routing of content. This intelligent delivery mechanism is driven by the mobile user's schedule and their task list, and is constrained by factors such as the available QoS.

Preferably, the content manager portion is driven by a set of ECA rules that are responsive to changes in a user profile to run executable code that modifies the delivery of content. ECA rules are used to implement the adaptive content engine's core profile and content management components. ECA rules are also used to control the semantic mark-up of content. These rules conform to the Open ECA Framework API that forms part of the W3C RuleML initiative.

Preferably, the content manager portion is adapted to identify content for delivery in dependence on data contained within a user profile. Preferably, content is delivered via a number of channels. Preferably, the content manager portion comprises a priortiser portion that manages the priority and frequency of delivery of these channels.

Preferably, the network infrastructure interface application comprises a services manager portion that manages transaction services on behalf of mobile users and which is responsive to changes in a user profile to modify a mobile user's access to transaction services.

Preferably, the service manager portion comprises a selector portion that maintains a dynamic model of relevant transaction services. This model is preferably updated in dependence on changes to a user's profile.

Preferably, the service manager portion is adapted to package client software into a number of sub-components that support functionality for different QoS levels. This allows a basic service to be provisioned and then subsequently augmented as and when the QoS permits. We term this “tear-off computing”.

Preferably, the services manager portion is driven by a set of ECA rules that are responsive to changes in a user profile to run executable code that modifies the access to transaction services.

The network infrastructure interface application may be responsive to event changes in terms of the quality of service (QoS) provided by the network, particularly a wireless network connection, presented to the system as a “Δ-QoS” event stream. Alternatively, or in addition, the network infrastructure interface application may be responsive to event changes in a user's calendar presented to the system as a “Δ-calendar” event stream. Furthermore, the network infrastructure interface application may also be responsive to event changes associated with the user's location, the user's role, or the type of the user's communications device.

Typically, the system comprises a suitably programmed server connected to a network backbone of the enterprise which provides an interface, or middleware, between the enterprise and a mobile user and the network to which the mobile user's communications device is connected. The corporate network backbone itself would typically be connected to third party content and/or service providers to which the enterprise and/or mobile users may subscribe.

According to a still further aspect of the present invention, a personal communications device comprises a memory containing computer executable code which is operative to modify the content and/or access to services that is delivered to a user via a user interface of the communications device in response to event changes in the environment in which the user operates.

Preferably, the computer executable code comprises a device manager portion that receives event streams and which is responsive to up-date a device profile stored on the communications device in dependence on the event streams.

Preferably, the computer executable code comprises a channel/presentation manager portion that is responsive to changes in a user profile to modify the delivery of content to the user.

Preferably, the channel/presentation manager portion is driven by a set of ECA rules that are responsive to changes in a user profile to run executable code that modifies the delivery of content and/or access to services.

In a preferred implementation of the present invention, we provide a QoS-aware run-time infrastructure. This is achieved by bridging the gap between the network and application infrastructure in order to extract the raw network QoS information. This is then packaged and consumed by the application layer as a stream of Δ-QoS change events. In particular, we provide an event-driven application that leverages the run-time infrastructure and moderates its behaviour in response to changes in the underlying QoS. The present invention also ensures that such an application's behaviour is context-sensitive. That is, capable of dynamically adjusting its behaviour in response to important changes in the user's environment as well as being attuned to the network itself. For example, in the simplest case, the application could take into account whether a user is in an important meeting when deciding to forward a particular news flash as an audible alert or in silent mode.

### BRIEF DESCRIPTION OF THE DRAWINGS

Examples of the present invention will now be described in detail with reference to the accompanying drawings, in which:

FIG. 1 is a simplified network schematic;

FIG. 2 provides a high level logical overview of the ATF architecture;

FIG. 3 illustrates the position of the ATF and the server node; and,

FIG. 4 illustrates the ATF server-side components of the system.

### DETAILED DESCRIPTION

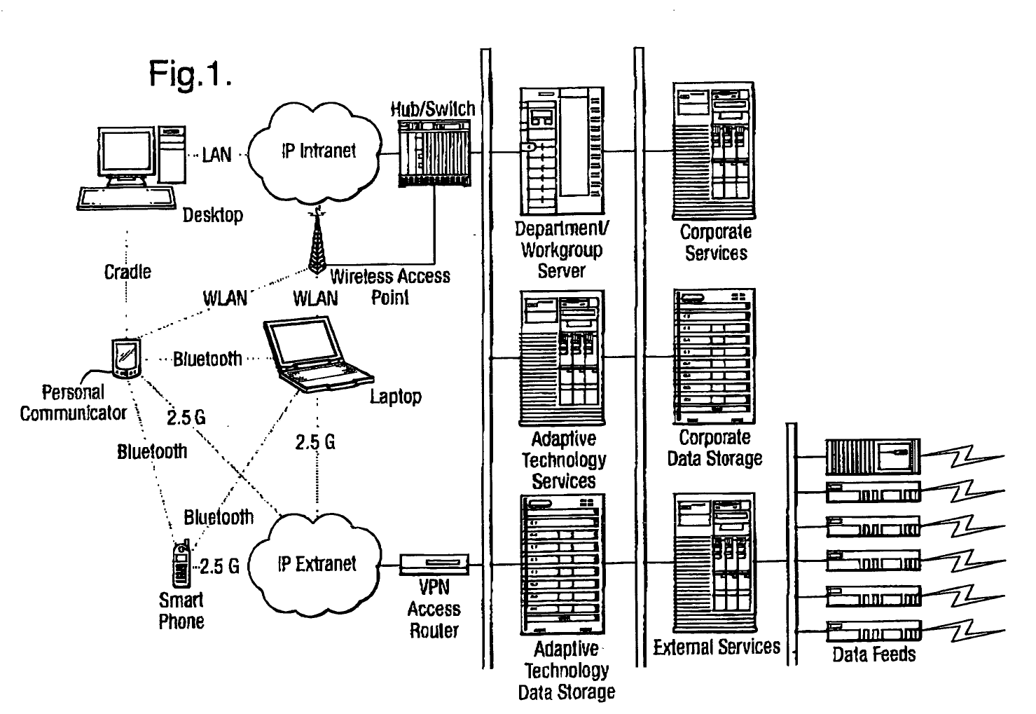

In the present invention, an Adaptive Technology Framework (ATF) operates in an enterprise configuration comprised of a network, server nodes supporting the ATF functionality, and the enterprise application nodes. A simplified network schematic is shown in FIG. 1.

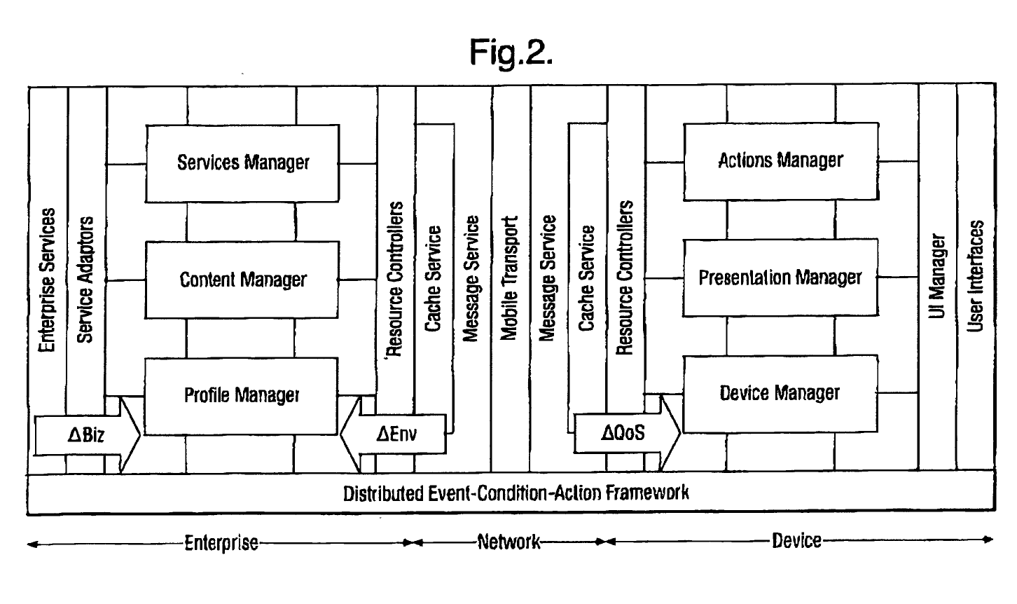

The high level logical ATF architecture is shown in FIG. 2. The left hand side of this figure shows the components of the ATF server node. These components adapt the content from enterprise applications for delivery via the network to the mobile device whose components are shown on the right hand side. These components also determine the services that can be accessed by the mobile device.

The Δ-Biz arrow represents event stream of changes in the mobile users' business context and role. The Δ-Env and Δ-QoS arrows represent event streams of changes in their physical environment.

The extent of any device-side components is determined by the quality of device, in particular, whether it can support a JVM or similar run-time application environment. A basic assumption is that the device can support a graphical user interface (GUI). For corporate users the target is a personal communicator class device.

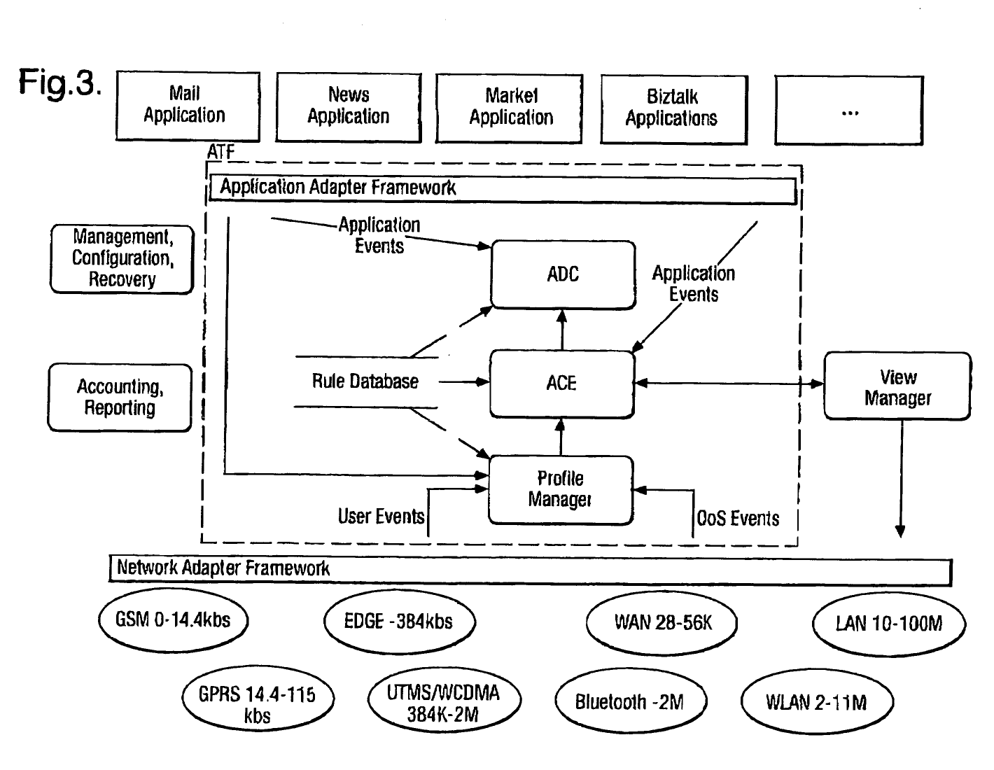

The position of ATF in the server node is shown in FIG. 3. Additional components for the management, configuration, accounting and reporting are shown. Standard or home grown functions can be employed which communicate the ATF through adapter interfaces to provide these functions. A variety of applications would be integrated via an application adapter framework portion of the ATF using mark-up adapters.

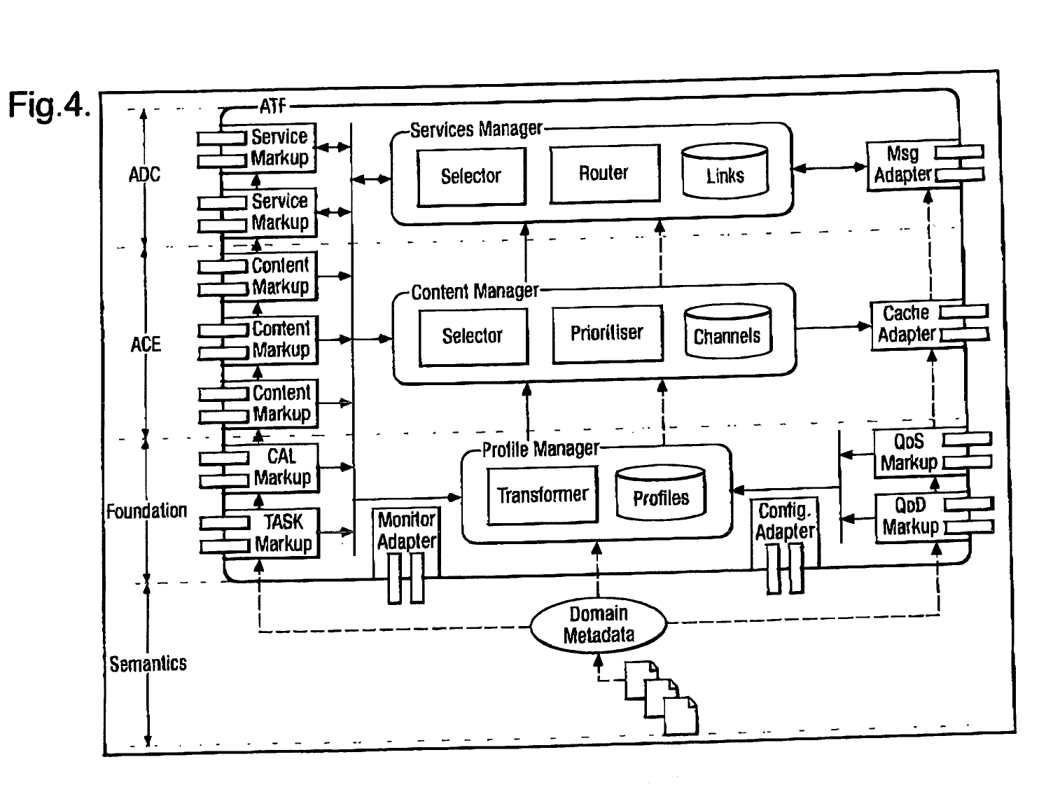

The ATF server-side components are shown in FIG. 4. There are five distinct logical components: Foundation, Adaptive Content Engine (ACE), Adaptive Delegation Controller (ADC), a set of adapters which provide the interface to and from the outside world, and a meta architecture which holds one or more ontologies relating to a business domain. An ontology represents the data model and business rules that determine how the ATF modifies the information and services delivered to the mobile device in accordance with prevailing conditions.

Underpinning all the logical components are the semantics provided by the domain specific metadata. This represents the data model and business rules that determine how the ATF modifies the information and services delivered to the mobile device in accordance with the prevailing conditions. The Profile Manager, Content Manager and Services Manager components all reference the same core meta architecture which enables the ATF to operate on a wide variety of business domains.

The ATF makes use of well-established content markup languages such as NewsML, MDML/MarketsML and iCalendar together with the Open ECA Framework, proposed as a core component of the RuleML initiative. Where appropriate ATF supports protocols associated with the emerging web services and B2B standards, notably WSDL, ebXML, and bizTalk.

The ATF object model is specified using an UML tool such as Rational Rose. ECA rules operate over this object model. Together with a domain specific topic hierarchy these can be thought of as constituting a primitive ontology: taxonomy+set of axioms/rules. Ultimately, the ATF is constructed using a combination of generic ontologies such as Dublin Core and industry specific ontologies such as IBM's Insurance Application Architecture. Domain metadata is specified in industry standard form using Extended Markup Language (XML) and Resource Definition Facility (RDF) documents as defined by W3C.

The ATF is an event-driven framework. Adapters interface with the external world and are an important source of events. In particular, business adapters receive input from the enterprise calendar application(s) and use rules-based semantic mark up of schedule (calendar and task) to transform and republish this information on user/group sub-topics e.g. <OrgID>.CALENDAR.<GroupID>.<UserID>. These events are consumed by the Profile Manager component. Environment adapters receive input from the network component and use rules-based semantic mark up of quality of service and quality of device published on user sub-topics e.g. <OrgID>.QOS.<UserID>. These events are consumed by the Profile Manager component. Content adapters receive input events from applications delivering content to the mobile device. They use rules-based semantic mark up in order to publish content on domain-specific topics. These events are consumed by the Content Manager component. Service adapters interface to enterprise services provisioned by the Service Manager on behalf of the mobile user. These services are accessed via standard protocols such as ebXML.

The foundation layer provides the profile, system, configuration and monitoring management and is made up a number of sub-components. The Profile Manger builds and maintains user/group profiles. These are complex structures containing information regarding roles, connections, schedule, hot topics, markets, delegation, etc. The Profile Manager receives events from Cal, Task and Environment adapters. It uses the information contained within these events to maintain the user's profile. Changes in the user profile are published on user sub-topics e.g. <OrgID>.PROFILE.<UserID>. These profile change events are picked up by and drive the ACE and ADC components.

An important subcomponent of the Profile Manager is the TimePlaceRole (TPR) Monitor. This is configured/programmed using ECA rules and is responsible for generating/synthesising specific context events. These events notify the Profile Manager and other components of important changes in context. For example, it can be set to generate the T-12 hours, T-4 hours and T-60 min meeting alerts which will drive updates to user profiles which will in turn result in increased priority being given to information related to a meeting as it gets closer.

Users are able to override the Profile Manager's standard calendar-driven mode to look ahead to a future point in time or focus on a particular task. In this case the standard user profile is suspended while override is in effect. In addition, users are able to modify some aspects of their profile such as their hot topics as these are a combination of personal and programmed preferences. To support these features the Profile Manager will provide additional application program interfaces (API). These will enable the Service Manager to provide users with remote access to the Profile Manager.

Monitor adapters provide interfaces to external reporting, accounting and system monitoring components. They listen on particular monitor topics. All components contain functions for reporting their activity to a monitor topic. Configuration adapters provide interfaces for external configuration and system management components. They receive configuration change events and update the configuration of a particular component.

The ACE component receives application input events and profile change events. It modifies the content for delivery to the mobile device based on information from the user's profile and business rules defined in the business domain ontology that is applicable for the user's place, time and role. The ACE layer is made up of a number of sub-components. A Content Manager modifies content to be delivered to mobile users. In order to do this it subscribes to profile topics. A selector sub-component maintains a dynamic model of what constitutes relevant content for a particular user. This model is modified on-the-fly to reflect the dynamic changes to users' profiles as they move through time and space. The model is implemented as a series of channel definitions. A channel is an abstraction that corresponds to e.g. a component of a mobile device display such as a tab and will be composed of content sourced using different topics. Therefore the content subscriptions reflect the relevance of particular topics.

Since content subscriptions are logically grouped into different channels, a Prioritizer sub-component is provided to manage the priority and frequency of delivery of these channels.

Content is delivered via channels. These are implemented using an industry standard delivery mechanism such as LiveReport™. A cache adapter enables the Content Manager to interface to the preferred delivery mechanism.

The Adaptive Delegation Controller (ADC) layer is made up of a number of sub-components. A Services Manager manages transaction services on behalf of mobile users. In order to do this it subscribes to profile topics. A Selector sub-component maintains a dynamic model of relevant transaction services that is modified on-the-fly to reflect the dynamic changes to users' profiles as they move through time and space. The Selector is responsible for provisioning these services over-the-air (OTA) if required. Service provisioning is optimised to take account of the prevailing environment. For example, client software can be packaged into sub-components that support functionality for different QoS levels. In this way, the basic service can be provisioned and then augmented as and when the QoS allows. Provided that an application or service can be packaged in this way, this approach minimizes the use of the available bandwidth between the server and the device. The discipline of using ECA rules to specify an application's behaviour and then classifying them according to minimum QoS precondition required lends itself to this approach.

Intelligent routing is used for point-to-point messaging provided that appropriate permissions are set. Messages that require an explicit acknowledgement can either be dispatched using a message adapter that interfaces directly to downstream message service such as iBus//Mobile™ or via a link abstraction. In the case of the latter, acknowledgement would then be handled via client side ECA rule.

Assuming that device is sophisticated enough to support JVM or similar there will be a set of device-side ATF components. In particular, the Services Manager is reflected on device-side by an Actions Manager, the Content Manager is reflected on device-side by a Channel/Presentation Manager and the Profile Manager is reflected on device-side by a Device Manager

In the following description an illustrative scenario outlines how the system would operate in practice. The scenario details the activities of a user of the system and the events that flow within the system. The events are prefixed with a descriptive tag that relates back to the component within the system that is either creating the event or processing the event. These events are summarised in Table 1 below.

TABLE 1

| Event type | Producer | Consumer | Description |
|---|---|---|---|
| Environment | Network | Profile | Changes in the QoS |
| | Adapter | Manager | and QoD that flow |
| | | | from the underlying |
| | | | network support |
| | | | software. |
| Profile | Profile | ACE, ADC | Changes in the user |
| | Manager | | profile. |
| Context | TPR Monitor | Profile | These are events |
| | (Subcomponent | Manager, | that represent |
| | of | ACE, ADC | changes in the time |
| | Profile | | window of relevance |
| | Manager) | | and are produced |
| | | | by the TimePlaceRole |
| | | | monitor and cause |
| | | | the recipients to |
| | | | re-evaluate content |
| | | | and service relevance, |
| | | | priorities and |
| | | | routing. |
| Application | Application, | Profile | These events carry |
| | ACE, ADC | Manager, | content and service |
| | | ACE,ADC | data. Typically these |
| | | | are generated by the |
| | | | mobile user or by an |
| | | | ECA [user-defined] |
| | | | rule triggered on |
| | | | their behalf. |
| Calendar | CAL Adapter | Profile | These events carry |
| | | Manager | calendar data. |
| Task | Task Adapter | Profile | These events carry |
| | | Manager | task data. |
| Content | Content | ACE | These events carry |
| | Adapters | | the raw content |
| | | | destined for a |
| | | | mobile user. |
| Service | Service | ADC | These events carry |
| | Adapters | | the raw service data |
| | | | destined for a |
| | | | mobile user. |
| Channel | ACE, ADC | Channel | These events carry |
| | | Adapter | the modified content |
| | | | for delivery to the |
| | | | mobile user. |
| Monitor | All | Monitor | These events carry |
| | | Adapter | information on how |
| | | | the system is oper- |
| | | | ating and are |
| | | | intended for management |
| | | | and accounting |
| | | | applications. |
| Configuration | Configuration | All | These event carry |
| | Adapter | | configuration |
| | | | changes. |

The following scenario has been annotated with the events that are flowing during the scenario. To relate back to the preceding diagrams look up the event type in the above table and identify the producing and consumer components for an event.

Scenario Analysis

PocketWorkflow™ is the generic name for the mobile applications infrastructure we provide. In the following scenario analysis, we assume that the mobile applications infrastructure has been configured to support an investment banker (IB) as he goes about his business at Megabank. In this scenario analysis the services are simply referred to as myPocketWorkflow (myPW).

Overnight

Before signing off for the night, IB always docks his PDA in its cradle if he is at home. This is linked to his desktop PC that is connected to the Internet via an ADSL broadband link. Docking the PDA secures a high bandwidth connection to Megabank over a Virtual Private Network (VPN).

QoS Event—IB's PDA has high end VPN connection

Background transfer of all emails, voice mails (transcribed) and instant messages enabled

IB has a busy day tomorrow. At 10am he has a meeting scheduled with Wired and Broadcast (W&B), one of Megabank's most important clients. W&B is currently sitting on US$10 billion in cash and is looking for an acquisition. At 1pm he has a luncheon with his boss to discuss Megabank's One-to-NoOne strategy as at 3pm he and his boss are meeting with One-to-NoOne, another important client. At 7pm IB is booked on the evening flight to Frankfurt. He has a meeting with Bavaria Telecom at 9:30am the following day so will have to go direct to the airport after his One-to-NoOne meeting.

Bavaria Telecom and Megabank have a long relationship. IB is expecting this meeting to be quite relaxed. He is attending the meeting with his Frankfurt colleagues who are preparing the presentations. IB has been asked to be at this meeting as the industry expert and is expecting to provide a general market overview.

IB is aware that Megabank is going to release a very strong “buy” recommendation for Bavaria Telecom's shares within the next few days so he has already added Bavarian Telecom to his Hot Topics even though the meeting is still 36 hours away.

Overnight a series of context events are triggered by TPR monitor and processed by ACE.

Context Event—T-12 hour alert for W&B meeting (10pm)

Profile Event—W&B meeting added to IB's profile with Level 2 priority

Content Manager updates its view of IB's schedule

Background W&B meeting materials retrieved and sent to PDA

Context Event—Roll-over (12am)

Profile Event—Bavarian Telecom meeting added to IB's profile with Level 3 priority because although it is not within next 24 hours ACE infers that it is important as it is also one of IB's Hot Topics

Content Manager updates its view of IB's schedule

Background Bavarian Telecom meeting materials retrieved and sent to PDA

Context Event—T-12 hour alert for One-to-NoOne luncheon (1am)

Profile Event—One-to-NoOne luncheon added to IB's profile with Level 2 priority

Content Manager updates its view of IB's schedule

Background One-to-NoOne briefing materials retrieved and sent to PDA

Context Event—T-12 hour alert for One-to-NoOne meeting (3am)

Profile Event—One-to-NoOne meeting linked to luncheon on same topic and added to IB's profile with Level 2 priority

Content Manager updates its view of IB's schedule

Additional background One-to-NoOne meeting materials retrieved and sent to PDA

Context Event—T-4 hour alert for W&B meeting (6am)

Profile Event—W&B meeting amended in IB's profile with Level 1 priority

Content Manager updates its view of IB's schedule

Content Manager subscribes to increased range of W&B related content

Starting the Day

IB gets up and has breakfast. It is 7am. IB is enjoying a cup of coffee with his wife. In the past IB would have had to leave the house about now to ensure that he left himself enough time to drop in to his bank's corporate HQ Vulture's Peak en route for his first meeting. Fortunately, myPW has eliminated the need for this daily pilgrimage so nowadays he doesn't go via his office except for those rare occasions when his boss calls a specific early morning meeting.

He takes his PDA out of its USB cradle. This breaks the high bandwidth connection to Megabank's private virtual network. The device automatically seeks and secures a good quality GPRS connection.

QoS Event—IB's PDA has high quality mobile VPN connection

Background transfer of all emails, voice mails (transcribed) and instant messages disabled

Prioritised transfer of emails, voice mails and instant messages enabled

Overnight, the PDA has synchronised with Megabank's message server. IB now has to hand his overnight emails and phone messages and all the news releases and market updates relevant to the day's meetings available.

Additionally, IB's myPW has cached the CRM data he requires for the W&B meeting. A quick glance at the PDA tells him that his secretary has arranged for the car to collect him at 9am. He already knew this but it is comforting to see that it is in the system.

IB makes a note to call his Hong Kong office in a few minutes. W&B has a massive operation in the Far East.

Reviewing Emails

IB selects his myPW Messages tab and drills down on his Emails.

This morning IB has received thirty-six emails. Not too bad—some days he is bombarded with more than fifty overnight.

One email in particular catches his eye. It has been flagged as urgent by the sender and given a high delivery priority as a result. It is from Stanley, a Megabank colleague in Sydney. TelOne, a major Australian telecoms company may be getting into trouble—like all good stories this is just a rumour at this stage.

Tracking the TelOne Rumour

IB notes that myPW has recognized that TelOne is a company in the sector he covers and highlighted it. He double clicks the smart button on his PDA and watches as TelOne is added to his personal Hot Topics so that he will be automatically alerted if there is any news, research or messages relating to TelOne

Application Event—Hot Topics change request published

Profile Manager processes change to IB's profile

Profile Event—TelOne added to Hot Topics with Level 1 priority

Content Manager updates its view of IB's profile and starts subscribing to TelOne news

If something does break regarding TelOne, he would like to have this to hand prior to the W&B meeting.

Email arrives from Megabank Analyst with W&B report attachment

Email Adapter publishes time stamped notification that there is an internal W&B report available

Content Manager updates W&B meeting notes to reflect this fact and publishes change with Level 1 priority

Meanwhile myPW automatically prompts IB to ask him whether he wants to add TelOne to his list of Hot Stocks. He confirms this.

Application Event—Hot Stocks change request published

Profile Manager processes change to IB's profile

Profile Event—TelOne added to Hot Stocks with Level 1 priority

Content Manager updates its view of IB's profile and starts subscribing to TelOne stock quote

[Separate Thread] Meeting Event—W&B meeting notes update received

Previously, IB has set up a number of custom rules that check things like meeting note updates. One of these pre-emptively requests a report as soon as it becomes available whenever it relates to a meeting that is within T-4 hours time frame. The W&B report falls into this category.

Application Event—Download W&B report request published

It's 4pm in Australia. The Australian exchanges will be open for another hour. IB clicks across to his Hot Stocks tab. The markets have been quiet overnight—a bit of a slide on the Nikkei but nothing dramatic.

Meanwhile, the city is waking up and mobile network usage spikes dramatically.

QOS Event—IB's PDA has poor quality mobile connection

Content Manager downgrades frequency of delivery on all but Level 1 priority channels

Content Manager receives W&B report download request

IB notes that TelOne is now being tracked. He double clicks on TelOne to pull up its price history and fundamentals for the last month.

Application Event—Price history request queued

Content Manager receives price history request, retrieves information via appropriate content adapter and sends this to PDA

The graphic quickly pops up as IB's myPW is configured to automatically assign this type of request an “Immediate Delivery Priority”. This tells the system that this information is to be regarded as extremely important and thus should be given priority over any other information being pushed to the PDA.

In this instance, there is not sufficient bandwidth to provide the price history data requested and process IB's rule-driven request to deliver the latest W&B report from the Megabank analyst. Therefore a brief summary is sent and the full report cached until sufficient bandwidth is available. That is, unless it is specifically requested by IB in the meantime. As a general rule user originated requests are assigned an immediate delivery priority since these are usually regarded as system overrides.

Content Manager publishes synopsis of Megabank analyst's report

IB notes TelOne is off a little but nothing to indicate any major selling.

Business Meeting Alerts

Meanwhile, the bandwidth improves.

QoS Event—IB's PDA has medium quality mobile connection

Content Manager upgrades frequency of delivery on Level 2 priority channels

Content Manager is now able to publish Megabank analyst's full report

The PDA vibrates gently in IB's hand. This is to notify him that the report from the Megabank analyst has been automatically retrieved as per his preset rule.

Since the W&B meeting is now less than three hours away, myPW has already automatically assigned anything relating to this a ‘Level 1 Priority’. This ensures that W&B information takes priority over anything but the most urgent request.

IB notes the time stamp on the W&B report.

“Poor chap”, he thinks, “He should get himself one of these PDAs”. In fact, even Megabank has yet to see the efficiencies of myPW permeate the entire organisation. At this stage, only a pilot group of investment bankers have this capability.

Anyway, the analyst has updated his cash flow forecasts for W&B. Their cash mountain is starting to balloon at a substantial rate and is now predicted to exceed US$15 billion within six months. Some of the major shareholders are asking for this cash to be distributed. IB knows that W&B would rather make an acquisition, but picking exactly the right acquisition is proving to be elusive.

Since Europe is an hour ahead, news updates relating to W&B, One-to-NoOne and Bavaria Telecom are also starting to come through in advance of these meetings. Content Manager has previously established subscriptions relating to IB's upcoming meetings and set up logical channels with the appropriate priority: W&B (Level 1), One-to-NoOne (Level 2) and Bavaria Telcom (Level 3).

News Adapter publishes W&B story

Content Manager picks up story and sends this down W&B channel with Level 1 priority

The time is now 7:30am. IB picks up the phone to Hong Kong and asks for Kasahara-san. Kasahara-san is an American educated Japanese national on secondment to Megabank's Hong Kong office. He is also the account officer for W&B in South East Asia. He confirms the analyst's view. In the Far East as well, the W&B shareholders are becoming unsettled by the large cash build up in the company and the apparent unwillingness of management to deploy it. IB asks Kasahara-san if he has heard anything about TelOne—nothing other than the market rumours emanating from Sydney.

Reviewing Voice Mails

7.50am. IB goes back to his myPW Messages tab and drills down on his Voice Mails.

There are three voice mails and it only takes a couple of moments to review each since they have been automatically transcribed and while he is doing this the available QoS changes once again.

QoS Event—IB's PDA has low quality mobile connection

Content Manager downgrades frequency of delivery on all but Level 1 priority channels

IB stores two of these voice-to-text messages on his To Do list and assigns them a low priority. He plans to action these items upon his return from Frankfurt in a couple of days time.

Application Event—ToDo list updates queued

These updates are non-urgent and are cached on the PDA pending a better connection

The only one of immediate relevance is from his boss changing the venue and the time for lunch that is now 11.45am. IB redirects this message to his secretary and presses the send button. This action automatically generates an email to his secretary and updates his diary.

Application Event—Email queued pending an improvement in the quality of service

QoS Event—IB's PDA has high quality mobile connection

Content Manager upgrades frequency of delivery on all channels Email successfully published

Megabank's corporate email system receives email and updates calendar

Calendar Event—Lunch venue/time change published

Context Event—T-4 hours alert for One-to-NoOne luncheon (Note that this was originally scheduled to fire at 8.00am but has been brought forward due to change in diary entry)

Profile Event—One-to-NoOne luncheon amended in IB's profile with Level 1 priority

Content Manager subscribes to increased range of W&B related content Meeting update sent to PDA

IB looks thoughtfully at his PDA. The screen layout, its overall operation, its general look-and-feel is very similar to his main workstation at the office. He was sceptical when the IT people first told him they were developing ‘tear-off’ computing. He had difficulty in understanding the term. Now he knows exactly what they meant.

“Marvellous,” he thinks as he pours himself another coffee and uses his PDA to flip channels on his TV and catch the 8.00am news bulletin on BBC News 24.

A Change of Plan

8.15am. IB has the whole day mapped out or so he thinks.

Instant Message Service Adapter receives an urgent instant message for IB

Service Manager sends this to IB's PDA with ‘Immediate Delivery Priority’

IB's PDA springs to life with “Don't Panic”—a sample taken from Hitch Hiker's Guide to the Galaxy which he has programmed his PDA to use out of hours to alert him if there is an urgent message—much to everyone's annoyance.

IB picks up his PDA and quickly goes to his myPW Messages tab. He sees that there is an instant message from the car firm alerting him to the fact that his car will be arriving in 15 minutes time. “That's a bit early,” he thinks.

IB's regular driver usually turn up 10 to 15 minutes ahead of schedule but it is unusual for him to arrive a full half an hour before he is needed but the message explains why—there are some emergency road works in one of the tunnels en route to W&B so the driver wants to get away early.

IB quickly gets ready, slips his PDA into his coat pocket, picks up his mobile phone, and collects his small overnight bag.

Meeting Alarm

The trip through his immediate neighbourhood is swift. However, as predicted, once he is in the tunnel, the traffic slows substantially.

QoS Event—IB's PDA has low quality mobile connection

Content Manager downgrades frequency of delivery on all but Level 1 priority channels

Context Event—T-60 minutes to W&B meeting (9am)

Meeting alert sent to PDA

Now that he is in work mode, IB takes out his PDA when it beeps primly to remind him of his upcoming meeting. He taps his At a Glance tab then clicks on the Next Meeting icon that is flashing red. This takes him to the W&B meeting details.

A new series of tabs is displayed—background information, the latest reports lodged on Megabank's CRM system including the newly updated cash-flow report, the agenda and participants at the meeting. IB refreshes his memory on each of the W&B executives with whom he will be meeting in just under an hour before clicking across to his Messages tab.

Black Spot

Just then his connection stalls as he reaches a notorious blank spot in the tunnel.

QoS Event—IB's PDA has stalled mobile connection

Content Manager suspends delivery on all channels

Fortunately, myPW has continued to cache IB's emails and deliver these in priority order according to IB's schedule. That is, unless a higher priority has been assigned to the email by its author.

As with voicemail it has taken a little education to get IB's colleagues/contacts to understand when to use this feature as well as to ensure the appropriate coordinates are included in the title bar for each email but this has quickly become a reinforcing loop—the more precise the information, the more useful the service.

IB is reviewing his twelfth email as the car starts on the upward slope that marks the approach to the exit of the tunnel and his PDA re-establishes its connection with the external world.

QOS Event—IB's PDA has low quality mobile connection

Content Manager upgrades frequency of delivery on Level 1 priority channels

PDA begins sending queued information in priority order

Breaking News on TelOne

News Adapter publishes update on TelOne

Content Manager prioritizes this update (Level 1) and sends it to PDA

Suddenly the PDA begins beeping loudly and vibrating urgently in his hand. “What's going on?”, exclaims IB out loud as he sits up sharply in the back of the car.

IB notices his Hot Topics tab is flashing a vivid, urgent, red.

IB is unaware of the sophisticated technology that is always operating in the background to support his myPW service but is happy to see that once again it has made sure that as soon as his connection was re-established he immediately received a pending ‘Level 1 Priority’ message. Even at this low quality of service, myPW ensures that the most efficient use of the available bandwidth is achieved.

IB taps the red flashing Hot Topics tab. A news release springs instantly onto the screen. Once again, myPW has performed by preemptively caching this bulletin directly onto his PDA.

Immediately after the close of the Australian stock market, TelOne has announced the resignation of its CEO. This is a direct response to TelOne's auditors uncovering an enormous hole in TelOne's accounts. “This is amazing!”, thinks IB. TelOne's CEO, Digby Rich had just been paid a substantial bonus. “How can this be?”. The story contains a degree of speculation that TelOne is unlikely to survive in its current format.

IB retrieves his mobile phone from his jacket pocket. No signal yet—the mouth of the tunnel was just coming into view.

His PDA beeps again. More stories are now being picked up from the news wires. IB switches the PDA to silent mode while he collects his thoughts. Finally out of the tunnel. His mobile rings. It's Stanley from Sydney—“You should see the news!”, Stanley gushes down the phone.

“If you mean TelOne—I've already seen it.”, responds IB. A moment's silence from Stanley who is somewhat taken aback. “What! You mean Richie's resignation? How could you?”

“New PDA.”, says IB. “It picked up the news a couple of minutes ago. Now listen carefully, there might be a deal in here . . . ”.

The following are further examples of how the intelligent delivery of information to the mobile user can improve the way they work.

Home Working

Alice Springs is employed as a senior merchandiser with a large chain of department stores, Heavenams and works at home one day a week. She has a desktop machine at home as well her desktop machine in the office. She really appreciates the ATF system because Alice receives over 100 emails a day. A lot of them are company, division and department wide distribution and they tend to mask out the critical ones related to her job. The ATF system, keying of Alice's diary and tasks, separates out the email and news related to tasks and calendar events in the near future. This enables Alice to work more efficiently because she is better able to manage her time in dealing with the stream of events that drive her work. Alice sees the same functionality whether she is working in the office or at home. For instance, Alice is working on two overseas deliveries which have fallen behind schedule. She has a meeting the following day at 9:00am to report to her boss on the current status. Overnight 30 email and news items come in, one of them is an email to say the lorry carrying the goods from Italy has been stopped and held at Calais because of illegal asylum seekers being found on the lorry. Alice was planning to get to work at 8:00 am to prepare for the meeting but a points failure causes her to arrive at the office at 8:55 am. She quickly logs onto to her system at the office, and sees that the email regarding the Italian delivery has been prioritised and is immediately apparent. She prints off the email and goes to the meeting able to report on the most up to date status on the deliveries.

On the Road

David Hanson is a divisional director with a large paint manufacturing company. David has a laptop that he plugs into a docking station when in the office in New Orleans. When visiting the company's factories and warehouses, he connects up to the network using wireless Bluetooth connections in the drop-in offices that located at the factories and warehouses. He also connects to the corporate network using a dialup VPN from home. David too suffers from email and information overload. When on the road, the ATF system keeps this traffic to the essential minimum by prioritising the information coming through to his laptop to those pieces of information which are important to his immediate tasks and meetings. David has a meeting scheduled with the warehouse manager at their facility in Houston, Tex. On the way to the meeting the factory manager of the Austin factory, which is the main supplier of the Houston warehouse, sends David an email to say that a wild cat strike is being called immediately. When David arrives at the warehouse goes into the drop-in room and synchronises his email. He immediately sees the email from the factory manager in Austin because it has been prioritised as very important. David goes into the meeting with the warehouse manager and immediately revises the agenda to deal with disruption to supplies from the Austin factory.

1. A system for providing content over a network from an enterprise to a mobile user comprising an enterprise network infrastructure interface application that is operative to modify the delivery of content to a user's communications device over the network in accordance with a user profile maintained within the system which is updated in response to one or more event streams generated within the system that describe changes associated with the environment in which the user operates.

2. A system according to claim 1, in which the network infrastructure interface application comprises a profile manager portion that receives event streams and which is responsive to update a user profile in dependence on the event streams.

3. A system according to claim 2, in which the profile manager portion is driven by a set of Event-Condition-Action (ECA) rules.

4. A system according to claim 1, in which the network infrastructure interface application comprises a content manager portion that is responsive to changes in a user profile to modify the delivery of content to the mobile user.

5. A system according to claim 4, in which the content manager portion forms part of an adaptive content engine comprising a set of distributed server components that implements dynamic rules-based selection, prioritisation and routing of content.

6. A system according to claim 4, in which the content manager portion is driven by a set of ECA rules that are responsive to changes in a user profile to run executable code that modifies the delivery of content.

7. A system according to claim 4, in which the content manager portion is adapted to identify content for delivery in dependence on data contained within a user profile.

8. A system according to claim 4, in which content is delivered via a number of channels.

9. A system according to claim 8, in which the content manager portion comprises a priortiser portion that manages the priority and frequency of delivery of the channels.

10. A system according to claim 1, in which the network infrastructure interface application comprises a services manager portion that manages transaction services on behalf of mobile users and which is responsive to changes in a user profile to modify a mobile user's access to transaction services.

11. A system according to claim 10, in which the service manager portion comprises a selector portion that maintains a dynamic model of relevant transaction services.

12. A system according to claim 11, in which the model is updated in dependence on changes to a user's profile.

13. A system according to claim 10, in which the service manager portion is adapted to package client software into a number of sub-components that support functionality for different quality of service (QoS) levels.

14. A system according to claim 10, in which the services manager portion is driven by a set of ECA rules that are responsive to changes in a user profile to run executable code that modifies the access to transaction services.

15. A system according to claim 1, in which the network infrastructure interface application is responsive to event changes in terms of the QoS provided by the network, presented to the system as a Δ-QoS event stream.

16. A system according to claim 1, in which the network infrastructure interface application is responsive to event changes in a user's calendar, presented to the system as a Δ-calendar event stream.

17. A system according to claim 1, in which the network infrastructure interface application is responsive to event changes associated with one or more of the user's location, the user's role, and the type of the user's communications device.

18. A system according to claim 1, comprising a programmed server connected to a network backbone of the enterprise which provides an interface between the enterprise and a mobile user, and a network to which the mobile user's communications device is connected.

19. A method of providing content over a network from an enterprise to a mobile user comprising the steps of receiving one or more event streams that describe changes associated with the environment in which the mobile user operates, updating a user profile associated with the mobile user in dependence on the received event streams, and subsequently modifying the delivery of content to the mobile user in dependence on the updated user profile.

20. A computer program product comprising computer executable code that is operative to receive event streams that describe changes associated with the environment in which a mobile user operates, update a user profile associated with the mobile user in dependence on the received event streams, and subsequently modify the delivery of content to the mobile user in dependence on the updated user profile.

21. A personal communications device comprising a memory containing computer executable code which is operative to modify the content and/or access to services that is delivered to a user via a user interface of the communications device in response to event changes in the environment in which the user operates.

22. A device according to claim 20, in which the computer executable code comprises a device manager portion that receives event streams and which is responsive to up-date a device profile stored on the communications device in dependence on the event streams.

23. A device according to claim 21, in which the computer executable code comprises a channel/presentation manager portion that is responsive to changes in a user profile to modify the delivery of content to the user.

24. A device according to claim 23, in which the channel/presentation manager portion is driven by a set of ECA rules that are responsive to changes in a user profile to run executable code that modifies the delivery of content and/or access to services.
